(19) United States
(12) Patent Application Publication
(10) Pub. No.: US 2016/0010665 A1
(43) Pub. Date: Jan. 14, 2016

(54) Control Plate

(71) Applicant: ElringKlinger AG, Dettingen (DE)

(72) Inventor: Jochen Schoellhammer, Dettingen (DE)

(21) Appl. No.: 14/865,549

(22) Filed: Sep. 25, 2015

Related U.S. Application Data
(63) Continuation of application No. PCT/EP2014/055628, filed on Mar. 20, 2014.

(30) Foreign Application Priority Data
Mar. 25, 2013 (DE) 102013205220.0

(51) Int. Cl. F15B 13/08; F16J 15/08

(52) U.S. Cl. CPC F15B 13/0828; F16J 15/0818; F16J 15/0825; F15B 13/081; F15B 2211/71

(57) ABSTRACT

In order to improve a control plate (10) for mounting between two hydraulic units (62, 64), in particular between two hydraulic units of a transmission, including an intermediate layer (12) having apertures (32, 34) for guiding fluid, and metal sealing layers (22, 24) that are arranged on either side of the intermediate layer and have apertures for guiding fluid, and sealing beads (112, 114, 116, 118) which run linearly between the apertures, for sealing between the intermediate layer and the opposing hydraulic units on either side thereof, such that an optimum seal is possible between the intermediate layer and the hydraulic units, it is proposed that, for sealing, the sealing beads abut by means of their bead feet (132, 134) against the intermediate layer and have on their side remote from the intermediate layer a bead crest (152) for linearly sealing to the respective hydraulic unit, and in that the sealing beads in the sealing layers are formed such that when the sealing beads are compressed in the course of installing the control plate between the hydraulic units a plasto-elastic deformation is established, at least in certain regions, and a sealing force above a predetermined minimum sealing force is achieved over the entire linear extent of the respective bead crest.

### CROSS-REFERENCE TO RELATED PATENT APPLICATION

This application is a continuation of International application No. PCT/EP2014/055628 filed on Mar. 20, 2014.

This patent application claims the benefit of International application No. PCT/EP2014/055628 of Mar. 20, 2014 and German application No. 10 2013 205 220.0 of Mar. 25, 2013, the teachings and disclosure of which are hereby incorporated in their entirety by reference thereto.

### BACKGROUND OF THE INVENTION

The invention relates to a control plate for mounting between two hydraulic units, in particular between two hydraulic units of a transmission, including an intermediate layer having apertures for guiding fluid, and metal sealing layers that are arranged on either side of the intermediate layer and have apertures for guiding fluid, and sealing beads which run linearly between the apertures, for sealing between the intermediate layer and the opposing hydraulic units on either side thereof.

Control plates of this kind are known from the prior art.

However, in those there is a continual requirement to optimise the seal between the intermediate layer and the hydraulic units.

The object of the invention is therefore to improve a control plate of the type mentioned in the introduction such that an optimum seal is possible between the intermediate layer and the hydraulic units.

### SUMMARY OF THE INVENTION

This object is achieved according to the invention with a control plate of the type mentioned in the introduction in that, for sealing, the sealing beads abut by means of their bead feet against the intermediate layer and have on their side remote from the intermediate layer a bead crest for linearly sealing to the respective hydraulic unit, and in that the sealing beads having the sealing layers are formed such that when the sealing beads are compressed in the course of installing the control plate between the hydraulic units a plasto-elastic deformation is established, at least in certain regions, and a sealing force above a predetermined minimum sealing force is achieved over the entire linear extent of the respective bead crest.

The advantage of the solution according to the invention can thus be seen in the fact that, as a result of the configuration of the shape of the sealing beads and the choice of material of the sealing layers, it is possible to achieve a behaviour of the sealing beads that makes a predetermined minimum sealing force achievable with the sealing beads, with a plasto-elastic deformation when the control plate is installed between the hydraulic units, regardless of the location at which the seal is to be made.

Here, it is particularly advantageous if the minimum force is 5 N/mm².

Further, it is preferably provided for the level of the sealing force that occurs when the control plate is installed to be limited such that the sealing force is preferably 100 N/mm² or less.

This restriction on large values for the sealing force has the advantage that in this way excessive deformation of the hydraulic units as the control plate is installed between them can be avoided.

As an alternative or in addition to the solution described, the object stated in the introduction is also achieved according to the invention with a control plate of the type mentioned in the introduction in that, with a deformation of the respective sealing bead to a bead height that is 5 pm greater than the bead height on complete compression, the sealing force is in a range of from 40 N/mm² to 80 N/mm².

As an alternative or in addition thereto, a further solution to the object according to the invention provides, with a compression of the sealing beads to a bead height that is 50 μm above the bead height on complete compression, for the sealing force to be in a range of from 5 N/mm² to 20 N/mm².

Further, as an alternative or in addition, with a further solution to the object according to the invention it is provided, after the plasto-elastic deformation for achieving the provided minimum sealing force, for the sealing beads to have a rebound travel of 10 μm or more—that is to say that despite the plasto-elastic deformation the sealing beads are still resilient and ensure a rebound of 10 μm or more.

A behaviour of this kind in the sealing beads is important so that the sealing beads can still follow deformations of the hydraulic units, where appropriate also in the region of the carrier plate, that occur in operation as a result of the effects of heat or pressure.

It is even more advantageous if, after the plasto-elastic deformation for achieving the minimum sealing force, the sealing beads still have a rebound travel of 15 μm or more.

In order in particular to achieve sufficient long-term loading capacity of the sealing beads, it is preferably provided, after at least 1.5 million deflection cycles, for the sealing beads still to have a rebound travel of 10 μm or more and the designated minimum sealing force.

As regards the formation of the sealing beads themselves, more detailed statements have not been made in the context of the explanation hitherto of the individual exemplary embodiments.

Thus, an advantageous solution provides for the bead height of the not yet deformed sealing beads in the sealing layer to be 10 μm or more.

It is even better if the bead height of the not yet deformed sealing beads in the sealing layer is 20 μm or more.

In order to achieve the advantageous properties of the sealing beads, it is preferably provided for the bead height of the beads not to be excessively great.

For this reason, it is preferably provided for the bead height of the not yet deformed sealing beads in the sealing layer to be 150 μm or less.

Further, more detailed statements have not yet been made as regards the bead width either.

Thus, an advantageous solution provides for the bead width of the not yet deformed sealing beads to be 0.5 mm or more.

A bead width of the sealing bead of this kind is partially responsible for the behaviour, in particular the plasto-elastic behaviour, of the sealing beads, and also contributes to ensuring the necessary rebound travel after the plasto-elastic deformation.

However, the bead width should moreover not be too great, and for this reason it is preferably provided for the bead width of the not yet deformed sealing beads to be 1.5 mm or less.

Further, more details have not yet been specified as regards the material thickness of the sealing layers either.

For this reason, it is preferably provided for the material thickness of the sealing layers to be 150 μm or more.

Preferably, however, the material thickness of the sealing layer should not be chosen to be excessively great, and for this reason it is favourably provided for the material thickness of the sealing layer to be 300 μm or less.

The sealing layer may at the same time be formed from the greatest variety of materials.

Thus, an advantageous solution provides for the sealing layer to be formed from steel, in particular carbon steel.

Further, the sealing layer is preferably formed from a material that has a modulus of elasticity of 500 N/mm² or less.

As an alternative or in addition to the solutions described above, a further solution of the object according to the invention provides for the sealing beads of the respective sealing layer to be provided on their side facing the respective hydraulic unit with an elastomer coating.

An elastomer coating of this kind provides the possibility of compensating for unevennesses in the surface of the hydraulic units in the region of their end faces facing the sealing layer and hence improving the sealed closure between the end face of the respective hydraulic unit and the respective sealing bead.

As an alternative or in addition, further, in the case of a solution to the object according to the invention, it is provided for the bead feet of the respective sealing layer to be provided on their side facing the intermediate layer with an elastomer coating.

An elastomer coating of this kind also provides the possibility of improving the seal between the sealing bead and the intermediate layer, in particular also as regards the seal in the event of unevennesses in the surface of the intermediate layer.

More detailed statements have not yet been made as regards the thickness of the elastomer coating, and in this case an advantageous solution provides for the elastomer coating to have a thickness of 10 μm or more.

In order that the thickness of the elastomer coating should not become excessively great, it is preferably provided for the elastomer coating to have a thickness of 50 μm or less.

In the context of the description hitherto of the individual exemplary embodiments of the control plate, the manner in which the intermediate layer is to be formed has not yet been discussed in more detail.

Thus, it has proved favourable for achieving the object stated in the introduction if the intermediate layer has a thickness of 800 μm or more in order to give the intermediate layer sufficient stability.

In particular, sufficient stability is required in order to ensure that the sealing beads have sufficient support relative to one another, for example if the sealing beads are arranged non-congruently on different sides of the intermediate layer.

In order that the material thickness of the intermediate layer should not become excessively great, it has proved advantageous if the intermediate layer has a material thickness of 2600 μm or less.

Moreover, more detailed statements have not been made as regards the material of the intermediate layer.

Thus, a favourable solution provides for the intermediate layer to be made from material that is free from spring steel.

Preferably, in this case the intermediate layer is formed from steel.

A favourable steel grade for forming the intermediate layer is carbon steel.

As an alternative thereto, however, it is also possible for the intermediate layer to be formed from aluminium.

In particular, it is preferably provided for the intermediate layer to be formed from an aluminium alloy.

A further alternative provides for the intermediate layer to be formed from AlMg₃ or AlMg_{4.5}Mn_{0.7}.

Also as regards the material properties of the intermediate layer, it has proved favourable if the intermediate layer is formed from a material that has a modulus of elasticity of 700 N/mm² or less.

Further features and advantages of the invention form the subject matter of the description below and the graphical representation of some exemplary embodiments.

### BRIEF DESCRIPTION OF THE DRAWINGS

FIG. 1 shows a perspective exploded illustration of a control plate according to the invention;

FIG. 2 shows a detail illustration of the control plate that is arranged between two hydraulic units, in a partial region defined by the section along line 2-2 in FIG. 1;

FIG. 3 shows a detail illustration of the control plate that is arranged between two hydraulic units, in a partial region defined by the section along line 3-3 in FIG. 1;

FIG. 4 shows an illustration on a larger scale, of a bead between an intermediate layer and a hydraulic unit, in the not yet deformed condition;

FIG. 5 shows an illustration similar to FIG. 4, of the bead in the deformed, installed condition;

FIG. 6 shows a graph which represents a plasto-elastic behaviour of the beads on being deformed during installation, in its relationship with the sealing force generated by the beads;

FIG. 7 shows an illustration similar to FIG. 6, with a correlation of the individual locations of deformation of the sealing beads in connection with an illustration of the sealing bead according to FIG. 2;

FIG. 8 shows an enlarged section of a sealing bead, similar to FIG. 4, of a second exemplary embodiment of a control plate according to the invention, with a complete elastomer coating of the sealing layer, and

FIG. 9 shows an enlarged section through a sealing bead similar to FIG. 4, having an elastomer coating of the sealing layer in the form of strips.

### DETAILED DESCRIPTION OF THE INVENTION

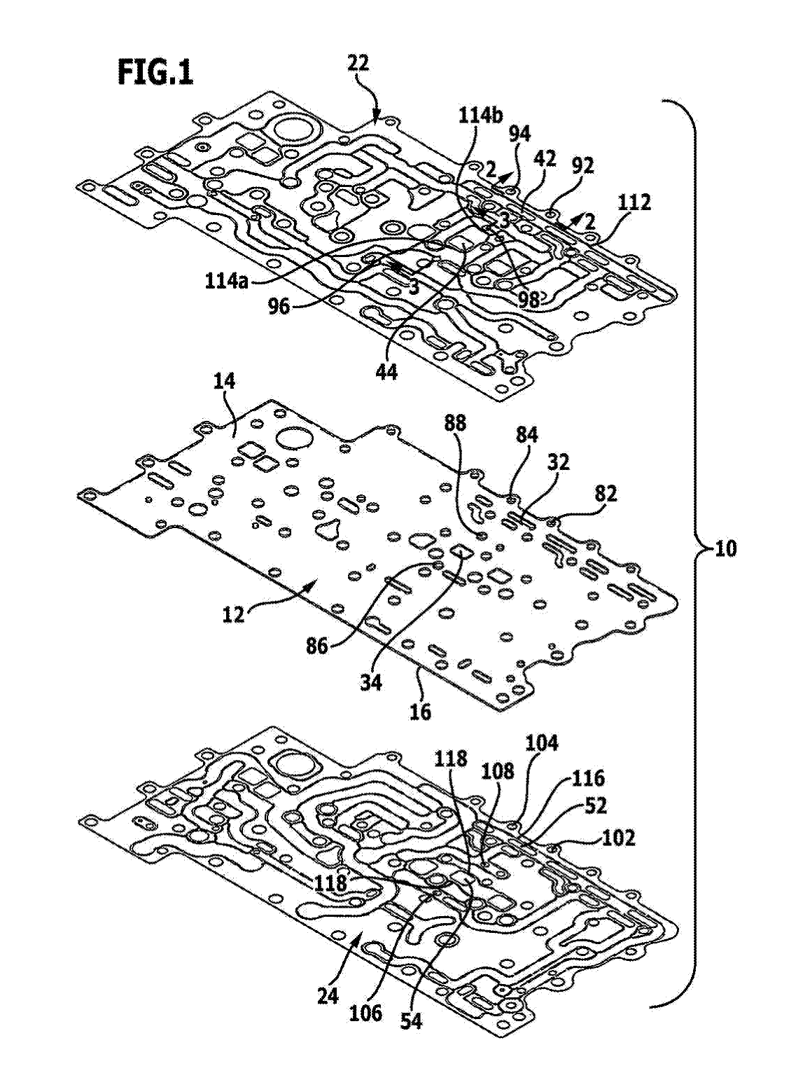

A first exemplary embodiment, illustrated in FIG. 1, of a control plate 10 according to the invention for mounting between two hydraulic units, in particular between two hydraulic units of a transmission of a motor vehicle, includes an intermediate layer 12 which is designated 12 as a whole and extends flat, and which has a first flat side 14 and a second flat side 16 on each of which a metal sealing layer 22 and 24 respectively is placeable as a functional layer.

In this arrangement, the intermediate layer is provided for example with a plurality of in particular differently shaped apertures 32 and 34 respectively, which allow a fluid to pass through the intermediate layer 22.

In a manner corresponding to the apertures 32 and 34, the first sealing layer 22 is also provided with correspondingly arranged apertures 42 and 44, and the second sealing layer 24 is also provided with apertures 52 and 54 respectively, corresponding to the apertures 32 and 34, with the overall result that a fluid, preferably a hydraulic fluid, can pass through the entire control plate 10, wherein this fluid then passes through the control plate 10 for example in the region of the apertures 42, 32 and 52, or passes through the control plate 10 for example in the region of the apertures 44, 34 and 54.

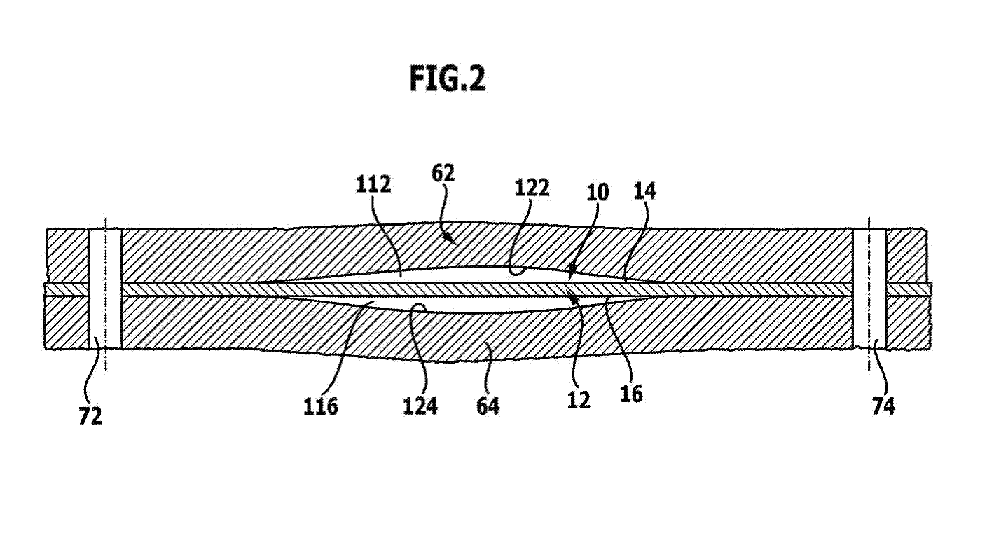

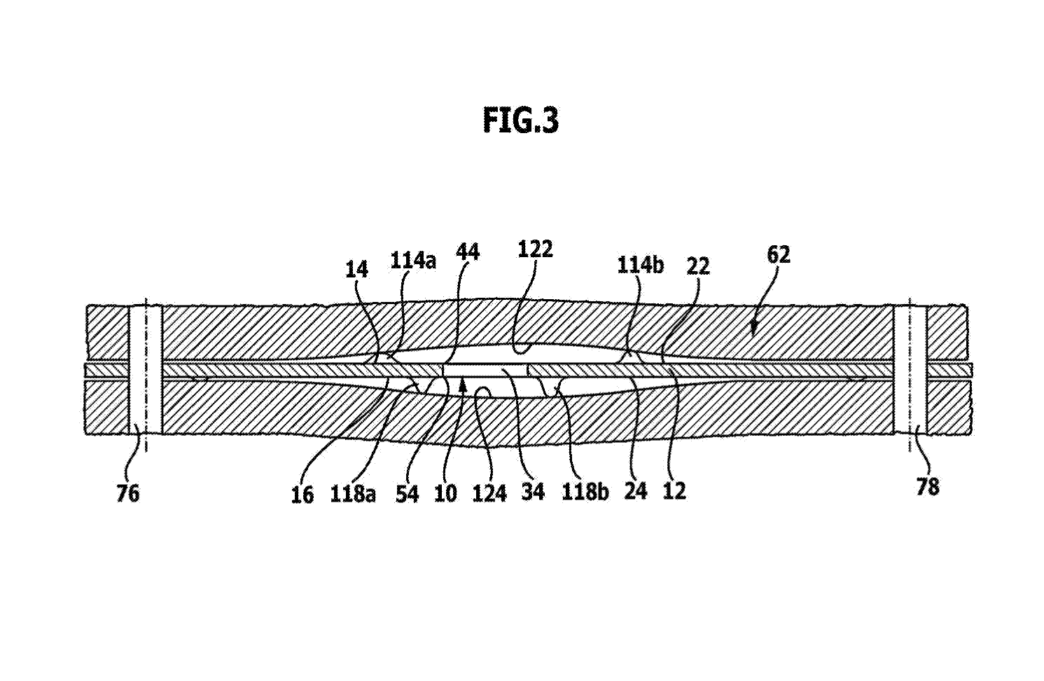

As illustrated in FIGS. 2 and 3, a control plate 10 of this kind is arranged between two hydraulic units 62 and 64, which in FIGS. 2 and 3 are illustrated only by a partial region that adjoins a partial area of the control plate 10 and in each case lies between two connection screws 72 and 74 or 76 and 78.

So that the two hydraulic units 62 and 64 can be connected by means of the connection screws 72, 74, 76, 78, both the intermediate layer 12 and the first sealing layer 22 and the second sealing layer 24 for this purpose have, in addition to the apertures 32 and 34, 42 and 44 and 52 and 54, screw apertures 82, 84 and 86, 88 respectively in the intermediate plate 12, 92, 94 and 96, 98 respectively in the first sealing layer 22, and 102, 104 and 106, 108 respectively in the second sealing layer 24, all of which are flush with one another such that the connection screws 72 and 74 and 76 and 78 respectively can reach through these screw apertures 82 to 88, 92 to 98 and 102 to 108 in order to connect the hydraulic units 62 and 64 firmly to one another.

In order to provide a seal on the one hand to the hydraulic units 62 and 64 and also to the intermediate layer 12 in the region of the apertures 32 and 34, 42 and 44 and 52 and 54, the sealing layers 22 and 24 are provided with sealing beads 112 and 114 that run in a line around the apertures 32 and 34 in the first sealing layer 22, and sealing beads 116 and 118 in the second sealing layer 124, wherein—as illustrated in FIG. 2—the sealing beads 112 creates a seal between the first flat side 14 of the intermediate layer 12 and an end face 122 of the first hydraulic unit 62 that faces the control plate 10, and the sealing bead 114 creates a seal between the first flat side 14 of the intermediate layer 12 and the end face 122 of the first hydraulic unit 62.

Further, the sealing bead 116, as illustrated in FIG. 2, creates a seal between the second flat side 16 of the intermediate layer 12 and an end face 124 of the second hydraulic unit 64 that faces the control plate 10.

Moreover, the sealing bead 114, as illustrated in FIG. 3, creates a seal between the first flat side 14 of the intermediate layer 12 and the end face 122 of the first hydraulic unit 62.

In the same way, the sealing bead 118, as illustrated in FIG. 3, creates a seal between the second flat side 16 of the intermediate layer 12 and the end face 124 of the second hydraulic unit 64.

In FIGS. 2 and 3, the deformation of the hydraulic units 62 and 64 between each pair of screws 72 and 74, and 76 and 78, that connect them is illustrated in exaggerated manner, wherein in each case in the region of the connection screws 72 and 74, and 76 and 78, the hydraulic units 62 and 64 act by means of their end faces 122 and 124 with maximum force on the sealing layer 22 and 24, with the result that even a bead that runs in the region around the connection screws 72 and 74, and 76 and 78, such as the bead 112 and 116 respectively, is pressed more or less flat, while the end faces 122 and 124 of the hydraulic units 62 and 64 in the regions between the connection screws 72 and 74, and 76 and 78, move increasingly away from one another, with the result that the end faces 122 and 124 have the greatest spacing from one another in an approximately central region between each pair of connection screws 72 and 74, and 76 and 78.

For this reason, the deformable sealing beads 112 and 114, and 116 and 118, are also required in order to achieve a reliable seal between the flat sides 14 and 16 of the intermediate layer 12 and the end faces 122 and 124 respectively of the hydraulic units 62 and 64 in the entire region between a pair of connection screws 72 and 74, and 76 and 78.

The sealing beads 112 and 114, and 116 and 118, thus always ensure that there is a reliable seal between the hydraulic units 62 and 64 and the intermediate plate 12, regardless of how far away the respective location of the seal is from the regions in which connection screws 72 and 74, and 76 and 78, pass through the control plate 10.

The sealing beads 112 and 114, and 116 and 118, could in theory be half beads.

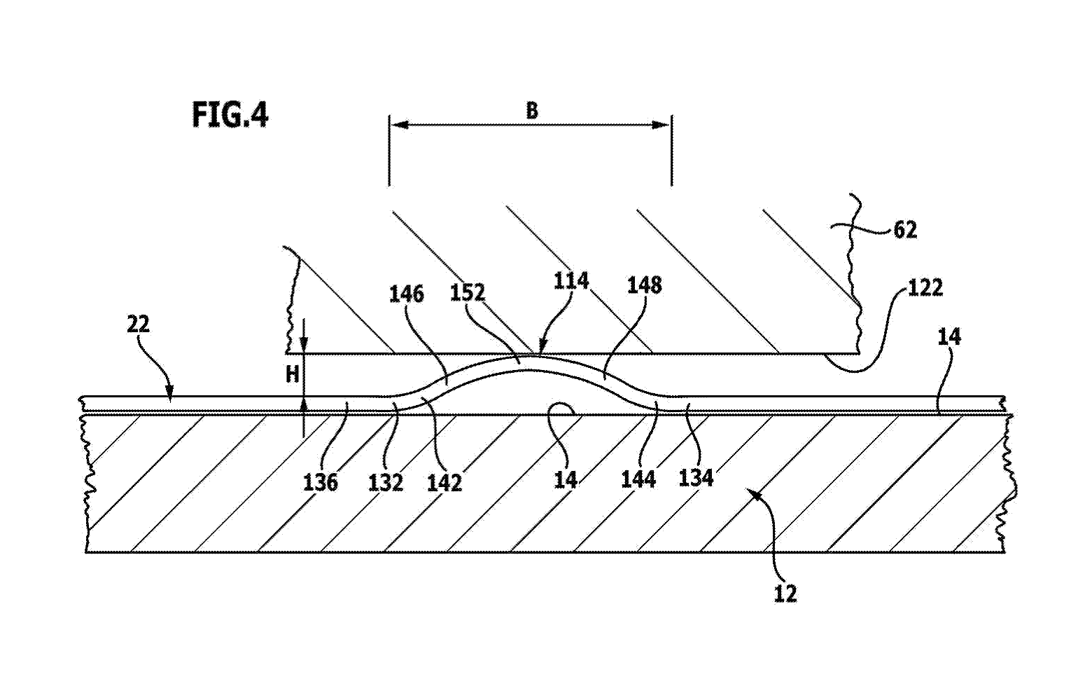

However, it is particularly advantageous if the sealing beads 112, 114, 116 and 118 are full beads, as illustrated in FIG. 4 by the example of the sealing bead 114.

Each of the sealing beads 112, 114, 116 and 118 includes two bead feet 132 and 134 which adjoin a flat region 136 of the respective sealing layer 22 and 24 and form a bead foot kink 142 and 144 respectively, from which the respective bead rises by means of bead flanks 146 and 148 to a bead crest 152, with the two bead flanks 146 and 148 merging with one another in the region of the bead crest 152 (FIG. 4).

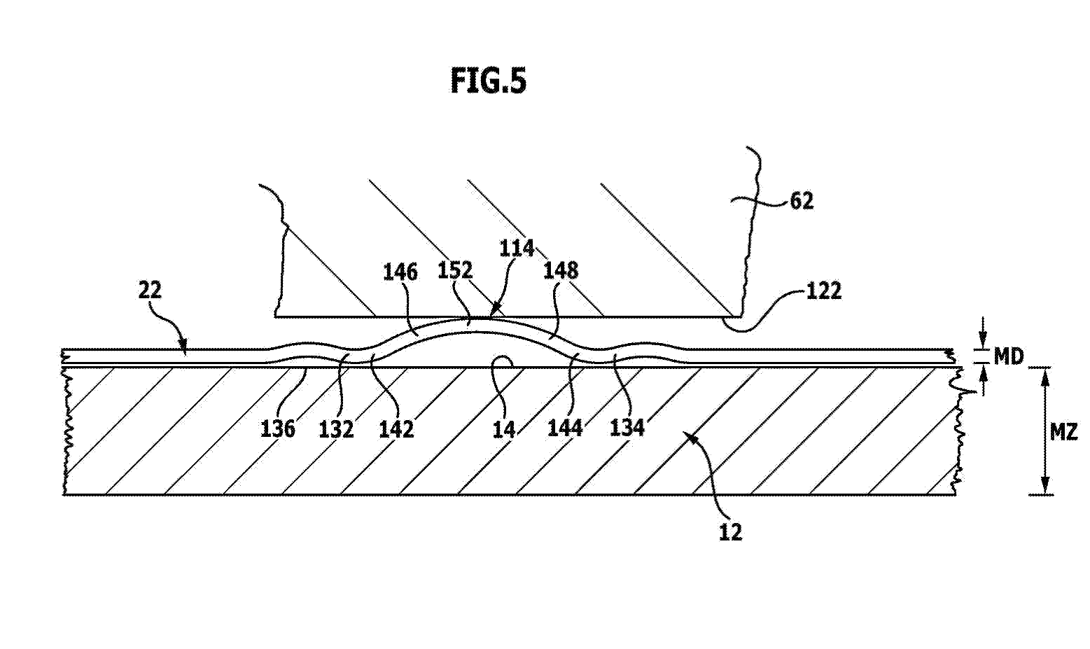

A load on the respective sealing bead, for example the bead 114, by the end face 122 of the first hydraulic unit 62 now results, in the region of the bead crest 152, in a linear seal between the bead 114 and the end face 122 of the respective—for example the first—hydraulic unit 62 on the one hand, and on the other hand in a linear seal, in the region of the first flat side 14 of the intermediate layer 12, in the region of the bead foot kinks 142 and 144, wherein—as illustrated in FIG. 5—the bead feet 132 and 134 are lifted slightly away from the first flat side 14 at their regions remote from the bead flanks 146 and 148, with the result that only in the region of the bead foot kinks 142 and 144 is the linear seal with the first flat side 14 of the intermediate layer 12 produced, as illustrated in FIG. 5.

As illustrated in FIG. 4, the sealing beads 112, 114, 116 and 118 have a bead height H in the undeformed condition which is in a range greater than or equal to 0.02 mm and less than or equal to 0.10 mm.

Further, the sealing beads have a bead width B in the undeformed condition—according to FIG. 4—which is in a range greater than or equal to 0.5 mm and less than or equal to 1.5 mm.

In order to achieve optimum deformation characteristics in the sealing beads 112, 114, 116 and 118, preferably the first sealing layer 22 and the second sealing layer 24 are made from a material which, even with a small deformation of the sealing beads, in particular in the central regions between each pair of connection screws 72 and 74 or 76 and 78, still always has sufficient minimum sealing force, wherein the minimum sealing force is to be 5 N/mm².

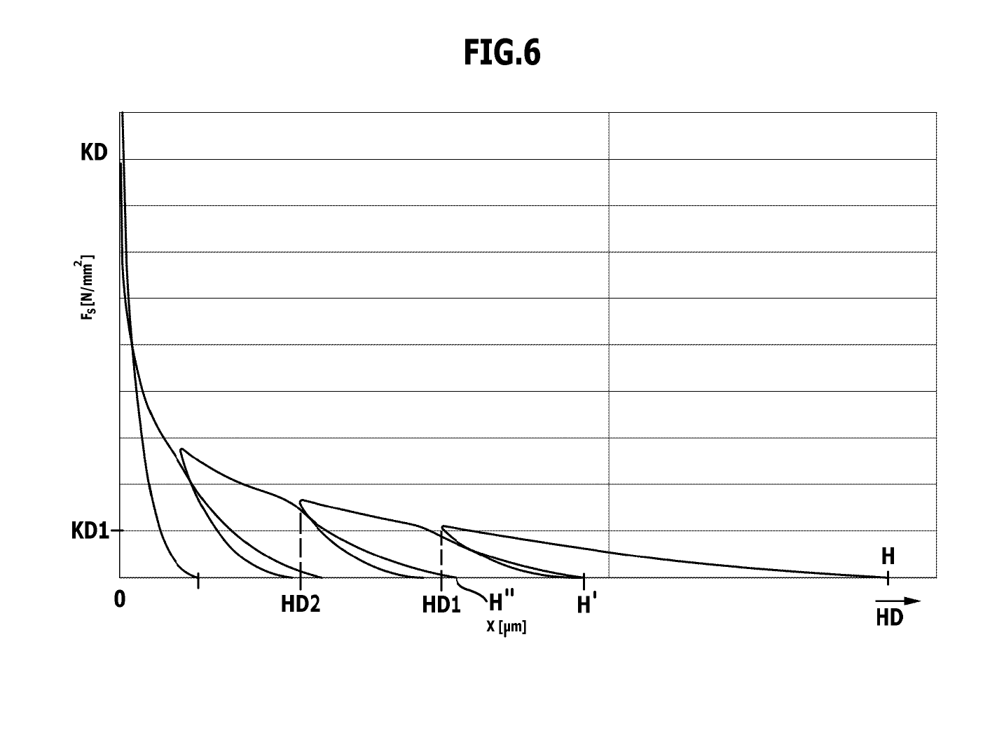

The behaviour of the material of the sealing layers 22 and 24 is illustrated schematically in FIG. 6, wherein FIG. 6 shows the sealing force KD over the height of the sealing beads HD in the deformed condition.

If for example a sealing bead having the height H is deformed, for example to the height HD1, then the sealing force KD increases to the value KD1.

In this arrangement, the deformation of the sealing bead from the height H in the undeformed condition to the height HD1 in the deformed condition is a plasto-elastic deformation, which can be seen from the fact that, in FIG. 6, on rebounding again from the height HD1 of the deformed sealing bead the height H is no longer achieved, but at most a height H′ that is smaller than the height H in the undeformed starting condition of the bead is achieved.

If, from the undeformed starting condition according to FIG. 4, the sealing bead having the height H is deformed for example to the height HD2, which is smaller than the height HD1, and can then rebound, the resulting bead height H″ is again smaller than the starting height H and even smaller than the height H′.

The sealing bead can also be brought to the height HD zero, that is to say be completely compressed, when the bead is in a region around one of the connection screws 72 or 74, or 76 or 78. In this case the force KD increases asymptotically towards infinity.

A characteristic feature of the behaviour of the material of the sealing layers 22 and 24 is the sealing force KD which is achievable if the respective bead 112, 114, 116, 118 is deformed plasto-elastically to a height that is greater by a defined value than the height HD zero—that is to say the height HD when the sealing bead is compressed completely.

If for example the sealing bead is deformed such that its height HD is still 50 μm above the bead height HD on complete compression, the sealing force should be in the range from 5 N/mm² to 20 N/mm².

If by contrast the sealing bead is compressed to a bead height HD which is 5 μm greater than the bead height HD on complete compression, the sealing force should be in the range from 40 N/mm² to 80 N/mm².

Further, the plasto-elastic deformation should be such that the sealing bead still has a rebound travel of 10 μm or more, preferably 15 μm or more, at the minimum sealing force, which should for example be around 5 N/mm² or more.

Moreover, in addition high demands are to be made of the cycling stability of the material of the sealing layer 22, 24.

Thus, it is preferably provided for the respective sealing bead, after at least 1.5 million deflection cycles, still to have a rebound travel of 10 μm or more and the designated minimum sealing force.

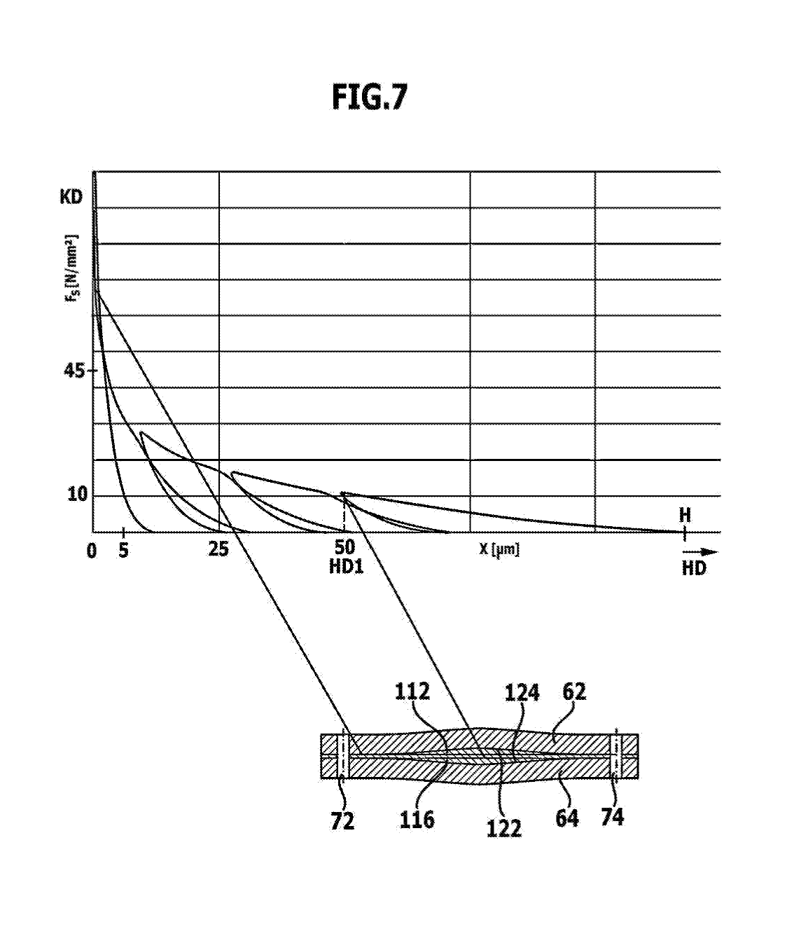

FIG. 7 once again illustrates the behaviour of the sealing force KD in relation to the height HD of the deformed sealing bead, and shows the relationship of these to the respective location of the seal between two connection screws 72 and 74.

Here, it is for example the case that, between the two connection screws 72 and 74, approximately centrally between these, the sealing bead undergoes a deformation that results for example in a bead height HD of 50 pm above the bead height HD on complete compression, that is to say a theoretical bead height of zero.

This is for example the bead height HD1, and at this bead height HD1 there is for example a sealing force KD of approximately 10 N/mm². If the sealing bead undergoes a more pronounced deformation, for example in the region close to the connection screw 72, then the sealing force KD increases as the bead height decreases, wherein at a bead height HD of for example 5 pm above complete compression there is a sealing force of approximately 45 N/mm².

As regards the material thickness of the sealing layers 22 and 24, more detailed statements have not yet been made.

Thus, it is preferably provided for a material thickness MD of the sealing layers 22, 24 to be for example 150 μm or more.

Preferably, a material thickness MD of the sealing layers 22, 24 of greater values is limited such that the material thickness is 300 μm or less.

Similarly, as regards the materials for the sealing layers 22 and 24, more detailed statements have not been made.

Preferably, it is provided here for the sealing layers 22, 24 to be formed from carbon steel.

Advantageously, the material of the sealing layers in this case has a modulus of elasticity of 500 N/mm² or less.

As regards the formation of the intermediate layer 12, in conjunction with the explanation above of the individual exemplary embodiments more detailed statements have not been made.

Thus, it is for example provided for the intermediate layer to have a material thickness MZ of 800 μm or more, wherein the material thickness MZ is preferably limited to values of 2600 μm or less.

Advantageously, the material from which the intermediate layer 12 is made is a material free from spring steel.

For example, the intermediate layer 12 is made from steel, wherein the steel is in particular a carbon steel.

As an alternative to forming the intermediate layer 12 from steel, it is also conceivable for the intermediate layer to be formed from aluminium or from AlMg₃ or from AlMg_{4.5}Mn_{0.7} or another aluminium alloy.

As regards the modulus of elasticity of the intermediate layer 12, it is favourable if the modulus of elasticity thereof is 700 N/mm² or less.

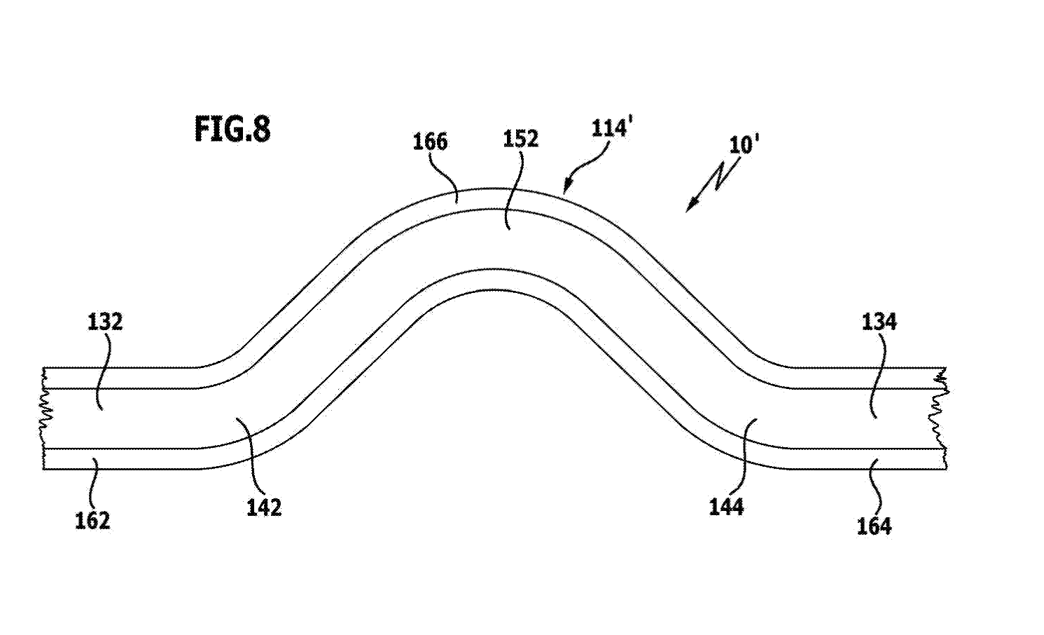

An additional improvement in the sealing behaviour of the sealing beads 112, 114, 116, 118 can be achieved in a second exemplary embodiment of the control plate 10′, as illustrated for example in FIG. 8, in that the sealing beads, for example the sealing beads 114′, is provided in the region of its bead feet 132, 134 and thus also in the region of the bead foot kinks 142, 144 with an elastomer coating 152, 154 on its side facing the intermediate layer 12, such that in this case the bead foot kinks 142 do not lie directly on the first flat side 14 of the intermediate layer 12 but only directly by way of the elastomer coating 152, 154, which creates the possibility of improving the seal tightness with the first flat side 14 of the intermediate layer 12 in that the elastomer coatings 152 and 154 are each also capable of compensating for unevennesses in the surface.

For example, in this case the elastomer coatings 152 and 154 have a thickness of 10 μm or more, wherein the thickness is favourably limited to 50 μm or less.

Further, it is also preferably provided for the bead 114′ to be provided in the region of its bead crest 152 with an elastomer coating 166 which is arranged on the side of the bead crest 152 facing the end face 122 of the first hydraulic unit 62, with the result that the bead crest 152 abuts by means of the elastomer coating 166 against the end face 122 of the first hydraulic unit 62.

In this arrangement, the elastomer coatings 162 and 164 and 166, as illustrated in FIG. 8, may be elastomer coatings that cover the entire surface of the sealing layers 22 and 24.

As regards the remaining features and the operation of the second exemplary embodiment, the statements made in respect of the first exemplary embodiment are included by reference in their entirety, with the same elements in each case being provided with the same reference numerals.

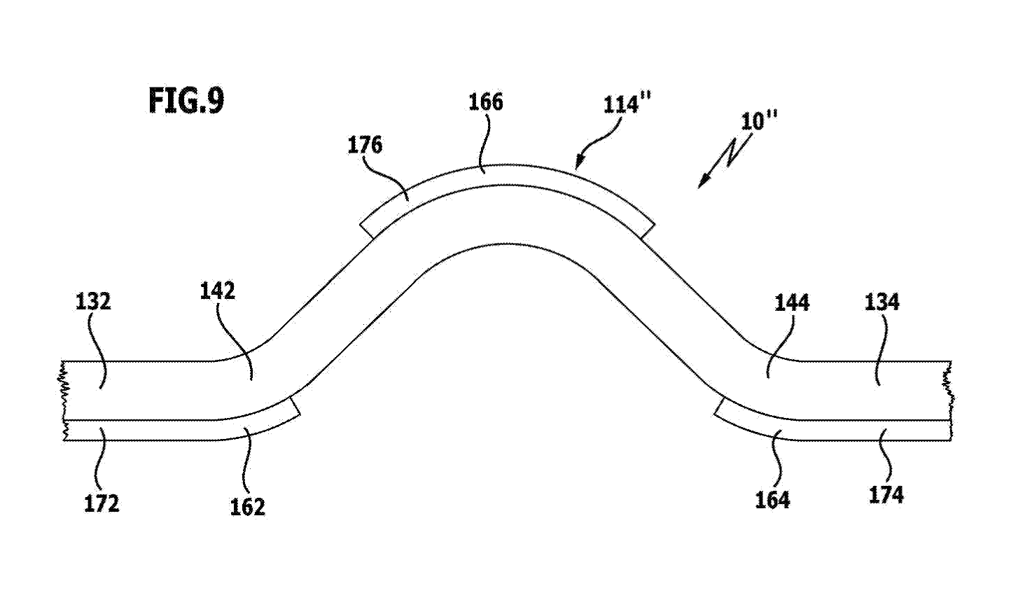

However, an alternative embodiment, explained in conjunction with a third exemplary embodiment of the control plate 10″, for example illustrated in FIG. 9, provides for the elastomer coatings 162, 164 and 166 to be formed by elastomer strips 172, 174 and 176 respectively, which run along the respective sealing bead, for example the sealing bead 114″, and may be applied to the respective side of the sealing layers 22 and 24, for example by a printing method.

As regards the remaining features and the operation of the third exemplary embodiment, the statements made in respect of the first exemplary embodiment are included by reference in their entirety, with the same elements in each case being provided with the same reference numerals.

In the second or third exemplary embodiment, preferably elastomer coatings made from ACM, AEM, FPM, MBA are used.

1. A control plate for mounting between two hydraulic units, in particular between two hydraulic units of a transmission, including an intermediate layer having apertures for guiding fluid, and metal sealing layers that are arranged on either side of the intermediate layer and have apertures for guiding fluid, and sealing beads which run linearly between the apertures, for sealing between the intermediate layer and the opposing hydraulic units on either side thereof, the sealing beads abut by means of their bead feet against the intermediate layer for sealing and have on their side remote from the intermediate layer a bead crest for linearly sealing to the respective hydraulic unit, the sealing beads in the sealing layers are formed such that when the sealing beads are compressed in the course of installing the control plate between the hydraulic units a plasto-elastic deformation is established, at least in certain regions, and a sealing force above a predetermined minimum sealing force is achieved over the entire linear extent of the respective bead crest.

2. A control plate according to claim 1, wherein the minimum sealing force is 5 N/mm².

3. A control plate according to claim 1, wherein the sealing force is 100 N/mm² or less.

4. A control plate according to claim 2, wherein the sealing force is 100 N/mm² or less.

5. A control plate for mounting between two hydraulic units, in particular between two hydraulic units of a transmission, including an intermediate layer having apertures for guiding fluid, and metal sealing layers that are arranged on either side of the intermediate layer and have apertures for guiding fluid, and sealing beads, which run linearly between the apertures, for sealing between the intermediate layer and the opposing hydraulic units on either side thereof, with a plasto-elastic deformation of the respective sealing bead to a bead height that is 5 μm greater than the bead height on complete compression, the sealing force is in a range of from 40 N/mm² to 80 N/mm².

6. A control plate for mounting between two hydraulic units, in particular between two hydraulic units of a transmission, including an intermediate layer having apertures for guiding fluid, and metal sealing layers that are arranged on either side of the intermediate layer and have apertures for guiding fluid, and sealing beads which run linearly between the apertures, for sealing between the intermediate layer and the opposing hydraulic units on either side thereof, with a plasto-elastic deformation of the sealing beads to a bead height that is 50 μm above the bead height on complete compression, the sealing force is in a range of from 5 N/mm² to 20 N/mm².

7. A control plate for mounting between two hydraulic units, in particular between two hydraulic units of a transmission, including an intermediate layer having apertures for guiding fluid, and metal sealing layers that are arranged on either side of the intermediate layer and have apertures for guiding fluid, and sealing beads which run linearly between the apertures, for sealing between the intermediate layer and the opposing hydraulic units on either side thereof, after the plasto-elastic deformation for achieving the provided minimum sealing force, the sealing beads still have a rebound travel of 10 μm or more.

8. A control plate according to claim 6, wherein after the plasto-elastic deformation for achieving the minimum sealing force, the sealing beads still have a rebound travel of 15 μm or more.

9. A control plate according to claim 6, wherein after at least 1.5 million deflection cycles, the sealing beads still have a rebound travel of 10 μm or more and the designated minimum sealing force.

10. A control plate according to claim 6, wherein the bead height of the not yet deformed sealing beads in the sealing layer is 10 μm or more.

11. A control plate according to claim 6, wherein the bead height of the not yet deformed sealing beads in the sealing layer is 20 μm or more.

12. A control plate according to claim 6, wherein the bead height of the not yet deformed sealing beads in the sealing layer is 150 μm or less.

13. A control plate according to claim 6, wherein the bead width of the not yet deformed sealing beads is 0.5 mm or more.

14. A control plate according to claim 6, wherein the bead width of the not yet deformed sealing beads is 1.5 mm or less.

15. A control plate according to claim 6, wherein the material thickness of the sealing layer is 150 μm or more.

16. A control plate according to claim 6, wherein the material thickness of the sealing layer is 300 μm or less.

17. A control plate according to claim 1, wherein the sealing layer is formed from carbon steel.

18. A control plate according to claim 1, wherein the sealing layer is formed from a material that has a modulus of elasticity of 500 N/mm² or less.

19. A control plate for mounting between two hydraulic units, in particular between two hydraulic units of a transmission, including an intermediate layer having apertures for guiding fluid, and metal sealing layers that are arranged on either side of the intermediate layer and have apertures for guiding fluid, and sealing beads which run linearly between the apertures, for sealing between the intermediate layer and the opposing hydraulic units on either side thereof, the sealing beads of the respective sealing layer are provided on their side facing the respective hydraulic unit with an elastomer coating.

20. A control plate for mounting between two hydraulic units, in particular between two hydraulic units of a transmission, including an intermediate layer having apertures for guiding fluid, and metal sealing layers that are arranged on either side of the intermediate layer and have apertures for guiding fluid, and sealing beads which run linearly between the apertures, for sealing between the intermediate layer and the opposing hydraulic units on either side thereof, the bead feet of the respective sealing layer are provided on their side facing the intermediate layer with an elastomer coating.

21. A control plate according to claim 18, wherein the elastomer coating has a thickness of 10 μm or more.

22. A control plate according to claim 19, wherein the elastomer coating has a thickness of 10 μm or more.

23. A control plate according to claim 20, wherein the elastomer coating has a thickness of 50 μm or less.

24. A control plate according to claim 21, wherein the elastomer coating has a thickness of 50 μm or less.

25. A control plate for mounting between two hydraulic units, in particular between two hydraulic units of a transmission, including an intermediate layer having apertures for guiding fluid, and metal sealing layers that are arranged on either side of the intermediate layer and have apertures for guiding fluid, and sealing beads which run linearly between the apertures, for sealing between the intermediate layer and the opposing hydraulic units on either side thereof, the intermediate layer has a material thickness of 800 μm or more.

26. A control plate according to claim 24, wherein the intermediate layer has a material thickness of 2600 μm or less.

27. A control plate according to claim 24, wherein the intermediate layer is made from material that is free from spring steel.

28. A control plate according to claim 24, wherein the intermediate layer is formed from steel.

29. A control plate according to claim 24, wherein the intermediate layer is formed from carbon steel.

30. A control plate according to claim 24, wherein the intermediate layer is formed from aluminium.

31. A control plate according to claim 24, wherein the intermediate layer is formed from an aluminium alloy.

32. A control plate according to claim 24, wherein the intermediate layer is formed from AlMg₃.

33. A control plate according to claim 24, wherein the intermediate layer is formed from AlMg_{4.5}Mn_{0.7}.

34. A control plate according to claim 24, wherein the intermediate layer is formed from a material that has a modulus of elasticity of 700 N/mm² or less.
